(19) United States
(12) Patent Application Publication
(10) Pub. No.: US 2023/0297997 A1
(43) Pub. Date: Sep. 21, 2023

(54) DEVICES, COMPUTER-READABLE MEDIA, AND SYSTEMS FOR IDENTIFYING PAYMENT GESTURES

(71) Applicant: MASTERCARD TECHNOLOGIES CANADA ULC, Vancouver (CA)

(72) Inventors: John Hearty, Vancouver (CA); Cristian Frentiu, Port Coquitlam (CA); Marc Grimson, Ithaca, NY (US); Ravi Santosh Arvapally, O'Fallon, MO (US); Rahul Deshpande, Chesterfield, MO (US); Amit Patankar, Chesterfield, MO (US)

(21) Appl. No.: 18/123,201

(22) Filed: Mar. 17, 2023

Related U.S. Application Data
(60) Provisional application No. 63/321,391, filed on Mar. 18, 2022.

(51) Int. Cl. G06Q 20/32; G06Q 20/38

(52) U.S. Cl. CPC G06Q 20/3278; G06Q 20/3821

(57) ABSTRACT

In one embodiment, the present disclosure includes a mobile computing device. The mobile computing device includes a communication interface, one or more sensors, a memory, and an electronic processor. The electronic processor is configured to detect a remuneration trigger event, retrieve sensor data from a sensor data repository in response to detecting the remuneration trigger event, determine whether a user of the mobile computing device intended to perform a remuneration action by applying a user intention model to the sensor data, generate remuneration credentials in response to determining that the user of the mobile computing device intended to perform the remuneration action, and control the communication interface to transmit the remuneration credentials to the terminal device to complete the remuneration action.

### CROSS-REFERENCE TO RELATED APPLICATION

This application claims priority to, and the benefit of, U.S. Provisional Application No. 63/321,391, filed on Mar. 18, 2022, the entire contents of which are incorporated herein by reference.

### FIELD OF THE INVENTION

The present disclosure relates generally to mobile computing devices. More specifically, the present disclosure relates to identifying remuneration gestures with mobile computing devices.

### BACKGROUND

Mobile computing devices with near field communication (NFC) may be used for remuneration actions with a terminal device. During a remuneration action, when a mobile computing device is brought closer to the terminal device, the mobile computing device uses NFC to retrieve remuneration data from the terminal device and provide it to a remuneration application executed on the mobile computing device. The remuneration application then responds with information needed for the remuneration action at the terminal device. The transaction is within the four-party transaction model used, where a cardholder in this case, the user of the mobile computing device with a remuneration vehicle stored on the mobile computing device.

However, the four-party model makes an ideal target for attacks by nefarious actors. These attacks effectively create a fifth-party model by inserting a nefarious actor between the mobile computing device and the terminal device. In these attacks, a nefarious actor/nefarious device makes the remuneration application on the mobile computing device respond with information needed for a remuneration action without the consent of a user of the mobile computing device.

In one example, a relay attack occurs when an external computing device imitates a terminal device to capture remuneration vehicle details from the remuneration application on the mobile computing device. In another example, a relay attack occurs when a rogue application tries to capture remuneration details by tricking the remuneration application and/or the mobile computing device into detecting a terminal device.

### SUMMARY

The aforementioned attacks can occur when a user is in proximity to a device that the remuneration application deems appropriate to communicate with even though the user has no intent to initiate a remuneration action. To increase the security of the four-party transaction model and reduce the effectiveness of attacks on the four-party model, a security layer may be added to the remuneration application that identifies one or more gestures of a user of the mobile computing device to determine the user's intended actions. Specifically, sensor data generated by the mobile computing device may be used to identify one or more gestures of a user of the mobile computing device that confirms the user's intended to perform a remuneration action in real-time.

In one embodiment, the present disclosure includes a mobile computing device. The mobile computing device includes a communication interface, one or more sensors, a memory, and an electronic processor. The communication interface is configured to communicate with a terminal device. The one or more sensors are configured to generate sensor data associated with the mobile computing device. The memory including a remuneration data repository configured to store remuneration data from the terminal device, a sensor data repository configured to store the sensor data that is generated by the one or more sensors, and a remuneration application including a user intention model. The electronic processor is communicatively connected to the memory, and the one or more sensors, the electronic processor configured to detect a remuneration trigger event, retrieve the sensor data from the sensor data repository in response to detecting the remuneration trigger event, determine whether a user of the mobile computing device intended to perform a remuneration action with the terminal device by applying the user intention model to the sensor data, generate remuneration credentials in response to determining that the user of the mobile computing device intended to perform the remuneration action, and control the communication interface to transmit the remuneration credentials to the terminal device to complete the remuneration action.

In another embodiment, the present disclosure includes a non-transitory computer-readable medium storing instructions that, when executed by an electronic processor, cause the electronic processor to perform a set of operations. The set of operations includes detecting a remuneration trigger event. The set of operations includes retrieving sensor data from a sensor data repository in response to detecting the remuneration trigger event. The set of operations includes determining whether a user of a mobile computing device intended to perform a remuneration action by applying a user intention model to the sensor data. The set of operations includes generating remuneration credentials in response to determining that the user of the mobile computing device intended to perform the remuneration action. The set of operations also includes controlling a communication interface to transmit the remuneration credentials to a terminal device to complete the remuneration action.

In yet another embodiment, the present disclosure includes a system including a terminal device and a mobile computing device. The terminal device is configured to communicate with a remuneration network, receive NFC communications, and send remuneration data in response to receiving the NFC communications. The mobile computing device including communication interface configured to communicate with the terminal device, one or more sensors configured to generate sensor data associated with the mobile computing device, a memory including a remuneration data repository configured to store remuneration data from the terminal device, a sensor data repository configured to store the sensor data that is generated by the one or more sensors, and a wallet application including a user intention model; and an electronic processor communicatively connected to the memory, and the one or more sensors, the electronic processor configured to detect a remuneration trigger event, retrieve the sensor data from the sensor data repository in response to detecting the remuneration trigger event, determine whether a user of the mobile computing device intended to perform a remuneration action by applying the user intention model to the sensor data, generate remuneration credentials in response to determining that the user of the mobile computing device intended to perform the remuneration action, and control the communication interface to transmit the remuneration credentials to the terminal device to complete the remuneration action.

### BRIEF DESCRIPTION OF THE DRAWINGS

FIG. 1 is a block diagram illustrating a system, in accordance with various aspects of the disclosure.

FIG. 2 is a diagram illustrating a first example of a relay attack.

FIG. 3 is a diagram illustrating a second example of a relay attack.

FIG. 4 is a diagram illustrating a spatial environment of the mobile computing device of FIG. 1, in accordance with various aspects of the disclosure.

FIG. 5 is a diagram illustrating a first example of identifying a user's intent at a payment terminal of a brick and mortar store, in accordance with various aspects of the disclosure.

FIG. 6 is a diagram illustrating a second example of identifying a user's intent at a payment terminal of a transit location, in accordance with various aspects of the disclosure.

FIGS. 7-10 are diagrams illustrating results of attacks in the system of FIG. 1, in accordance with various aspects of the disclosure.

FIGS. 11-14 are diagrams illustrating results of payment taps in the system of FIG. 1, in accordance with various aspects of the disclosure.

FIG. 15 is a flowchart illustrating an example method performed by the system of FIG. 1, in accordance with various aspects of the disclosure.

### DETAILED DESCRIPTION

Before any embodiments of the present disclosure are explained in detail, it is to be understood that this disclosure is not limited in its application to the details of construction and the arrangement of components set forth in the following description or illustrated in the following drawings. This disclosure is capable of other embodiments and of being practiced or of being carried out in various ways.

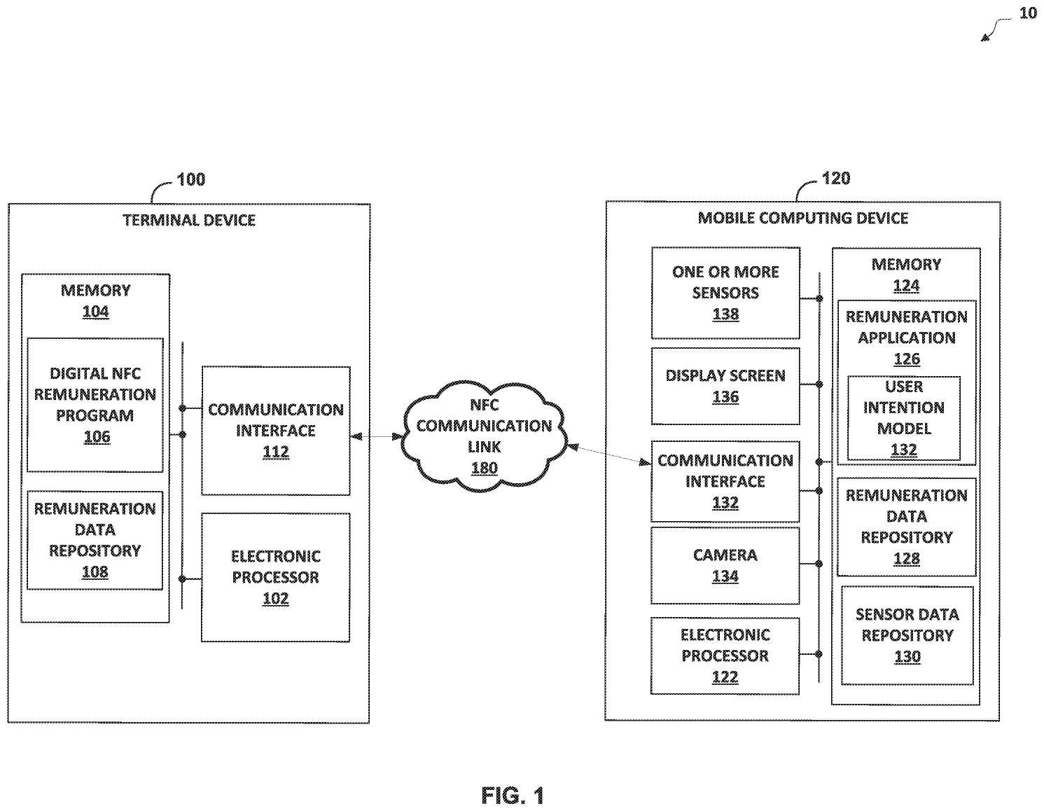

FIG. 1 is a block diagram illustrating a system 10. In the example of FIG. 1, the system 10 includes a terminal device 100, a mobile computing device 120, and an NFC communication link 180.

The terminal device 100 (also referred to as “a point-of-sale (POS) terminal”) includes an electronic processor 102 (for example, a microprocessor or another suitable processing device), a memory 104 (for example, a non-transitory computer-readable medium or a non-transitory computer-readable storage medium), and a communication interface 112. It should be understood that, in some embodiments, the POS terminal 100 may include fewer or additional components in configurations different from that illustrated in FIG. 1. Also, the POS terminal 100 may perform additional functionality than the functionality described herein. In addition, some or all of the functionality of the POS terminal 100 may be incorporated into other devices, for example, one or more remote servers. As illustrated in FIG. 1, the electronic processor 102, the memory 104, and the communication interface 112 are electrically coupled by one or more control or data buses enabling communication between the components.

The electronic processor 102 executes machine-readable instructions stored in the memory 104. For example, the electronic processor 102 may execute instructions stored in the memory 104 to perform the functionality described herein.

The memory 104 may include a program storage area (for example, read only memory (ROM)) and a data storage area (for example, random access memory (RAM), and other non-transitory, machine-readable medium). In some examples, the program storage area may store machine-executable instructions regarding digital NFC remuneration program 106 (also referred to as a “digital NFC payment program 106”). In some examples, the data storage area may store data regarding purchase details and payment data. The data storage area may include remuneration data repository 108 (also referred to as a “payment data repository 108).

Additionally, in some examples, the digital NFC payment program 106 also causes the electronic processor 102 to respond to a request from the mobile computing device 120. In these examples, the communication interface 112 may include communication circuitry that is configured to communicate with the mobile computing device 120 via the NFC communication link 180.

The communication interface 112 receives data from and provides data to devices external to the POS terminal 100, such as the mobile computing device 120 via the NFC communication link 180 or the second external computing device via distinct wired or wireless connection. In some examples, the system 10 may use a different wireless communication link in place of, or in addition to, the NFC communication link 180. For example, the system 10 may use a fifth-generation (i.e., “5G”) cellular communication link or a Wi-Fi communication link in place of, or in addition to, the NFC communication link 180.

In the example of FIG. 1, the mobile computing device 120 includes an electronic processor 122 (for example, a microprocessor or another suitable processing device), a memory 124 (for example, a non-transitory computer-readable storage medium), a communication interface 112, a camera 134, a display screen 136, and one or more sensors 138. It should be understood that, in some embodiments, the mobile computing device 120 may include fewer or additional components in configurations different from that illustrated in FIG. 1. Also, the mobile computing device 120 may perform additional functionality than the functionality described herein. In addition, some of the functionality of the mobile computing device 120 may be incorporated into other computing devices (e.g., incorporated into the POS terminal 100). As illustrated in FIG. 1, the electronic processor 122, the memory 124, the communication interface 112, the camera 134, the display screen 136, and the one or more sensors 138 are electrically coupled by one or more control or data buses enabling communication between the components.

The electronic processor 122 executes machine-readable instructions stored in the memory 124. For example, the electronic processor 122 may execute instructions stored in the memory 124 to perform the functionality described herein.

The memory 124 may include a program storage area (for example, read only memory (ROM)) and a data storage area (for example, random access memory (RAM), and other non-transitory, machine-readable medium). The program storage area includes a remuneration application 126 (also referred to as a “wallet application 126”) with a user intention model 132. The user intention model 132 is a model that is generated by applying machine learning techniques that develop user intention models (referred to as “user intention machine learning techniques”) to a dataset of sensor data representing device movement during the period of time prior to, and following, a contactless payment request. In some examples, the user intention model 132 is a pre-determined fixed model. In other examples, the electronic processor 122 continues to apply machine learning to new sensor data to revise the user intention model 132 and account for preferences of the user of the mobile computing device 120. In some examples, the user intention machine learning techniques may be offline or online machine learning. Additionally, in some examples, a human may be in the loop of the machine learning.

The user intention model 132 is a machine learning component that identifies payment gestures from other events. The user intention model 132 may be created by 1) data consolidation, 2) data cleaning, 3) feature engineering, 4) modeling, and 5) validation. Data consolidation includes consolidating dynamic and static data records. Each “record” to be analyzed by the user intention model consists of both static and dynamic data attributes. Dynamic attributes may be thought of as changing during the capture period of a particular record, and may be represented as series of values. Static attributes may be considered as only changing between records (even between records for the same device). Static attributes can also be thought of as slowly changing attributes, relative to the capture period of a record. Geolocation and device model are examples of static attributes.

Additionally, each sensor may provide multiple input variables. For example, accelerometer sensor data is represented across three dimensions. Each dimension may contain multiple values, captured as a series or vector. These values may be captured at regular intervals in time and the collection of value series (one series for each of X, Y and Z axes) may be captured simultaneously. The collection of value series may be accompanied by a timestamp and optionally by a numerical duration indicator. For example, a collection of x, y and z axis data series collected by an accelerometer at 0.1 s intervals starting from time 01/01/2021 8:00:00.000 might have a data structure expressed as follows: {“Timestamp”: “01/01/2021 8:00:00.000”, “Duration”: “0.5”, “Series”: {“x”: [−0.034, −0.036, −0.041, −0.04], “y”: [0.6, 0.64, 0.64, 0.63], “z”: [0.32, 0.21, 0.24, 0.22]}}. The same data structure holds true for gyroscopic data (which typically contains value series corresponding to pitch, yaw and roll dimensions) and other dynamic data attributes.

Additionally, static data may include parameters that aid more accurate or efficient modelling. For example, devices may be of different sizes or weights, or have differently located sensors, causing different handling gestures or varying data outputs when the same gesture is performed. Including a device model attribute enables subdivision of modelling train/test/validate activity by individual or grouped device models to improve model decision performance.

Other static parameters that may be used include geolocation and IP. These attributes do not directly assist modelling but may be used for confirmation checking against the location of sensor relative to the expected location (i.e., that of the tap terminal). These attributes shouldn't change within the span of a single record.

Data cleaning is a process that takes input data, including a vector of time series values for each raw input attribute, static attributes and in some cases, labels. Labels may include labels used in model development (e.g., class labels to support models in learning to classify payment vs. non-payment test cases), or labels generated in production use cases. Labels generated in production use cases may be generated in real-time (e.g., labels generated by other real-time systems, such as decision rule services) or generated post-hoc. Examples of post-hoc label generation include “human in the loop” methods (where a human worker manually labels individual cases, e.g., to detect model error or bias for refinement), or automated labelling using techniques such as semi-supervised learning.

Data cleaning is performed as a series of operations that include data validation, cleaning, and, verification. Data validation is an automated software process that includes checking for missing data values, mistyped data values, out-of-range or impossible data values, or outlying data values. Data may be validated both at the level of individual attributes (e.g., numerically) or structurally (e.g., a series may be checked to confirm it does not contain too many or few values, or an associated series such as accelerometer series may be compared to confirm they are of equivalent length). Data validation may be performed online (i.e., in real time by the service) or offline. Furthermore, an offline data evaluation process may include additional evaluation of data accuracy, for example, an analyst may intentionally perform a specific action multiple times, then inspect the generated data for accuracy (does it describe the action) and variance (does it remain consistent between trials).

Data cleaning is an automated software process that performs prescribed actions on input data, performing generic cleaning activity as well as specific cleaning actions based on the results of validation. Generic data cleaning activities may include value formatting to conform to the input specifications of the user intent model, artifact removal (i.e., the removal of formatting characters or artifacts sent by the mobile device) and data type conversions (most models expect input series to be expressed as vector or series objects, while most ingestion systems provide strings or j son dictionary entries—type conversion is required for compatibility). Generic data cleaning may also include rescaling or normalization of numerical values to lie within specified ranges or distributions (e.g., series values might be rescaled to lie within a 0 . . . 1 range).

In principle, every data validation outcome has an associated cleaning action. For example, missing values may be replaced by dummy-coded or inferred values. One embodiment might replace missing values in an accelerometer series using the closest available preceding and/or following values, or using regression to fit a projected value for a missing entry based on the rest of its series. In a basic example, the series: x=[0.1, 0.2, NA, 0.4, 0.5] might have the missing entry, NA, replaced with a value of 0.3 obtained by simple linear regression. In some embodiments, this substitution may be nonlinear and/or multivariate (using multiple series as input).

Data validation and cleaning activity may be performed by a component within a live service. Embodiments might include a containerized validation microservice, or a streaming processor that executes validation code against data streams. Data validation and cleaning may be executed by separate components, or a combined component. In some examples, separating the components may isolate changes and reduce complexity.

Data verification may be performed by a human, or automatically. The process of verification is one of assessing the product of data cleaning and the data cleaning process itself in order to assert validity in output and successful processing. An automated data verification process may include monitoring and alerting components in order to inform a human controller of risk factors. Risk factors may include an increase in outlying values, an increase in missing values, an increase in other data quality issues identified during verification, an increase in error codes returned by the verification and/or cleaning processor components, or other indicators of data quality, processing, or model risk.

As discussed, the input data includes accelerometer, gyroscope and light sensors, as well as static dimension variables such as geolocation, IP, timestamp and capture duration. All of these attributes have undergone data cleaning.

The preprocessing undertaken depends in part on algorithm selection. In some embodiments, the algorithm selected for modelling may be specialized to accept and model vector inputs—example algorithms include shapelet-based classifiers such as rotation forests.

Feature extraction approaches for vector-based, time-series specific algorithms may operate at a global or local level. A local level would involve sub-setting the data into slices, using sliding windows, or relative values (e.g., values obtained by performing an operation on each entry in a series using some lagged value from the same series. A basic example might involve subtracting each value from the one before in order to obtain the distance between successive values). In addition, operations may be performed on the subsets in order to extract features. In some embodiments, vector-based calculations may be performed on subsets of the data in order to ascertain the magnitude of direction change between two subsets of the sample period (whether the device acceleration direction changed). Measurement of this activity, e.g., in the periods before and after a tap event, or between the start and end of the capture period, allows one to detect the forward-and-back action associated with a device tap gesture.

Depending on the frequency of sampling, it may be necessary to perform down sampling—by sampling every n values from vector inputs and creating new down sampled features from those subsets. Alternatively, if within-sample variance is high, it may be necessary to smooth input vectors, for example by using sliding average techniques to generate smoothed features.

Additionally, it is necessary to generate features from the time-series signal data. As this data takes a waveform shape, time-series classification modelling approaches are appropriate, provided that the series data (e.g., accelerometer, gyroscope features) be transformed into lower-dimensional signals. In some embodiments, this transformation may be performed using a class of transformation called a wavelet transform.

In a wavelet transform application, a wavelet (a wave which only operates in a narrow band of time, for example a single oscillation) is slid passed across the feature input in chronological order. At each time step, a calculation is performed to compare the wavelet and feature data—in some embodiments this may be a multiplication of the wavelet and feature values. This calculation produces a coefficient for the wavelet and feature at that step. This process is performed at all time steps.

In some embodiments, this process is performed with a continuous series of different wavelets. In other embodiments, this process is performed with a discrete set of specific wavelets. In either case, the methodology is to assert that tap gesture data represents a waveform in the accelerometer/gyroscope feature space. Wavelet transformation generates coefficients that describe the similarity of that waveform to different wavelet shapes at different points in time. This enables a tap classification model to learn the coefficient patterns of genuine tap interactions, supporting the discrimination of tap from non-tap events.

Many algorithms benefit from transformation of the input data series into more simply expressed features (e.g., scalar features rather than vectors). In some embodiments, input data series may be translated into morphological features generated using the time domain. Example features include waveform amplitude, or area. In some embodiments, features may be generated against individual input signals, or against lower-dimensionality data series extracted from the inputs. Lower dimensional extracted data series may be obtained using approaches such as Principal Component Analysis (PCA) or Independent Component Analysis (ICA).

In some embodiments, wavelet transform and derived features may be used in order to improve model performance. In some embodiments, the set of input data used consists of: 1) input accelerometer series (accel_x, accel_y, accel_z), 2) input gyroscope series (gyro_x, gyro_y, gyro_z), 3) light sensor series (front_light, back_light). The output data produced consists of: 1) morphologically derived features for accel, gyro, (e.g., accel_x_area, accel_y_area . . . gyro_z_area, accel_x_amplitude, accel_y_amplitude . . . gyro_z_amplitude), 2) wavelet transform features for accel, gryo, light sensors for n-many wavelets (e.g., accel_x_wavelet1, accel_y_wavelet1 . . . light_back_waveletn), and 3) wavelet transform features for PCA-reduced accel, gyro, light sensor series for n-many wavelets (e.g., accel_PCA_wavelet1 . . . accel_PCA_waveletn, gyro_PCA_wavelet1 . . . gryo_PCA_waveletn, light_front_wavelet1 . . . light_back_waveletn).

During initial model training as well as potentially during any (online or offline) model iteration, it is necessary to evaluate the available feature set to choose a subset of features that perform particularly well. In addition to evaluating performance using true labeled data (tap/not-tap), it is necessary to evaluate the compatibility of features with one another for a modelling task. This is necessary because in contexts where multiple features are derived using the same input data, those derived features may contain overlapping, correlated or redundant information content. This may impede model learning by causing the model to learn irrelevant signals or become too dependent on multicollinear input.

In some embodiments, feature selection performed during model training is combined with analysis of model offline evaluation results, feature importance, and other decision support tools in order to identify feature risks and select an appropriate feature subset.

Developing an online service involves a process of offline model development. This data modeling activity requires a set of data input (that the model architecture chosen uses to learn how to discriminate between tap and non-tap events). It is conventional to subdivide this input data into multiple sets (usually test and train sets, with a validation set). Conventional data split proportions include 30:70 test:train or 30:60:10 test:train:validate. It also may be advantageous to create additional sets to handle edge cases or to build in bias mitigation—for example, a hold-out dataset may be retained to test the performance of a model against a sample of tap inputs performed by the differently able to confirm that the model does not bias against differently able groups.

The model training process is a supervised machine learning process using cleaned, subdivided labeled feature data and a learning algorithm. The supervised machine learning process may leverage one or multiple algorithms dependent on the type of feature data provided as input.

Where the feature data is entirely time-series signal data (e.g., wavelet transform coefficient series features), the machine learning algorithm chosen may include rotation forests or other suitable series data-compatible supervised machine learning algorithms. Where the feature data is entirely scalar data (e.g., morphological features such as waveform area, generated from input accel, gyro and light sensor series data), the machine learning algorithm chosen may include regression, random forest, support vector machine, perceptron-based models, or other suitable supervised machine learning algorithms.

Where the data is a blend of scalar and vector inputs, the user intention model may be comprised of multiple models, a scalar-compatible model and a series-compatible model. The results from each model, calculated separately, may then be resolved by a resolution layer, which takes the inputs from scalar and series/compatible models and makes a tap/not tap decision from them. This resolution layer may consist of a simple machine learning model, such as a regression model or a rules-based decision system, or any other suitable decision algorithm.

The labeled data used by the user intention model is generated by having a range of individuals of different heights and physical abilities use a dummy application that records gestures on a set of purpose-specific mobile devices. The individuals performed a set of tap gestures against mock and pay terminals to generate known tap label data. To generate negative class labeled data (non-tap labeled data), the individuals would also perform other gestures from a script, including putting the device into their pocket, waving the device, or other suitable non-tap movement.

Once a trained model is produced, it is evaluated with a validation process both for decision performance and for correctness, bias risk, etc. The model (or models) are translated into a decision-making algorithm. This may be done by extracting the model artifact and hosting it as a containerized service, which can be accessed via an API, through terminals or development environments, or via any other suitable interface. The data cleaning and feature extraction workflow may be transformed into a data preprocessing service, either as a containerized service that executes on demand, as API-accessible functionality, as executable code libraries, as streaming data preprocessing in a server or cloud environment or via any other suitable data processing architecture.

When data input is generated from a mobile computing device 120, the data input is preprocessed—cleaned and evaluated by a preprocessing service of the wallet application 126, then it's sent to a model of the wallet application 126 and model output is produced. In some examples, the model output and logging from preprocessing is sent to a remote monitoring UI of a remote server (not shown in FIG. 1), which allows solution owners to monitor solution performance, data quality issues, and other suitable parameters.

The data storage area includes a remuneration data repository 128 (also referred to as a “payment data repository 128”) and a sensor data repository 130. The payment data repository 128 stores the purchase details received from the POS terminal 100 and the payment credentials generated by the wallet application 126. The sensor data repository 130 stores the sensor data generated by the one or more sensors 138.

In some examples, the wallet application 126 may be a standalone application. In other examples, the wallet application 126 is a feature that is part of a separate application (e.g., the wallet application 126 may be included as part of a camera application, a banking application, or other suitable application).

The wallet application 126 causes the mobile computing device 120 to initiate communicate with the POS terminal 100. After initiating communication, the wallet application 126 causes the electronic processor 122 to request payment data from the POS terminal 100.

The wallet application 126 also causes the electronic processor 122 to control the one or more sensors 138 to collect sensor data at a suitable frequency on the mobile computing device 120 and store the sensor data in the sensor data repository 130. The suitable frequency determined from modelling trials. In some examples, the sensor data is stored in the raw format of each sensor. Additionally, the sensor data may include accelerometer data, gyroscopic data, light sensor data, orientation data, rotation vector data, touch location data, touch pressure sensor data, and/or touch gesture data collected by the one or more sensors 138.

For example, in a response to a trigger event (e.g., receiving payment data from the POS terminal 100), the wallet application 126 causes the electronic processor 122 to control the one or more sensors 138 to collect the sensor data in ten second windows. A ten second window may include a five second rolling window of sensor data prior to the event trigger (such as the “payment”) and a five second window after the event trigger. A timestamp of the triggered event is also given. Once the full ten seconds of sensor data is collected, the sensor data is sent to the sensor data repository 130. In some examples, the sensor data is stored in a JSON format.

In addition, a user of the mobile computing device 120 may supply a user name when using the wallet application 126, and an ID will be generated and stored with the sensor data for each event in order to identify between different users based on their usage of the mobile computing device 120. In some examples, the first time the user supplies the user name, the user is registered in a table stored in the sensor data repository 130. Additionally, in some examples, the sensor data may also be sent to a backend server along with the user name of the user that is registered to be stored in a table on the remote server. The wallet application 126 does not use names, personal data, or personally-identifiable information (“PIP”) in any algorithms or processing.

Further, any identifier stored in the NFC tag data will also be sent to the sensor data repository 130 (and/or the remote server). In some examples, this identifier is stored within a JSON string under a unique key, and the unique key may be checked against expected formats of the identifier before sending the identifier to a backend server. This check of the unique key is to avoid accidentally storing credential information stored on NFC tags, such as building identification (ID) cards.

In response to the trigger event, the wallet application 126 also causes the electronic processor 122 to retrieve the sensor data that was collected by the one or more sensors 138 from the sensor data repository 130 and identifies with the user intention model 132 whether the sensor data indicates that a user of the mobile computing device 120 intended to communicate with the POS terminal 100 and request payment data from the POS terminal 100. In particular, the electronic processor 122 identifies with the user intention model 132 whether the sensor data indicates the user of the mobile computing device 120 intentionally placed the mobile computing device 120 near a POS terminal to make a payment (see FIGS. 5 and 6 below).

To identify whether the sensor data indicates the user of the mobile computing device 120 intentionally placed the mobile computing device 120 near a POS terminal, the electronic processor 122 retrieves sensor data that corresponds to the trigger event. The electronic processor 122 then determines with the user intention model 132 whether the sensor data of the mobile computing device 120 is consistent with a user's intent to make a purchase. In some examples, the electronic processor 122 may determine with the user intention model 132 that the sensor data is indicative of the following: 1) the mobile computing device 120 is lying on a flat surface, 2) the mobile computing device 120 is in a user's pocket, 3) a user is browsing the internet on the mobile computing device 120, 4) a user is scrolling through a news feed, 5) a user is watching videos on the mobile computing device 120, 6) a user is playing a mobile game on the mobile computing device 120, 7) a user is typing an email on the mobile computing device 120, 8) a user is taking a video or photo on the mobile computing device 120, 9) a user is walking with the mobile computing device 120 in their hand, pocket, backpack, purse, handbag, briefcase, 10) a user is driving with the mobile computing device 120, 11) a user is putting the mobile computing device 120 in their pocket, and 12) a user is pulling the mobile computing device 120 out of their pocket. In these examples, the electronic processor 122 may then in real-time infer with the user intention model 132 that the above situations indicate the user had no intention to make a purchase relative to the trigger event. In some examples, real-time is a timeframe that occurs in milliseconds or other suitable timeframe that occurs nearly immediately.

Additionally, in some examples, the electronic processor 122 may determine with the user intention model 132 that the sensor data of the mobile computing device 120 is indicative of the following: 1) the mobile computing device 120 is moved near a POS terminal for a period of time and then moved away from the POS terminal, or 2) the mobile computing device 120 is moved near a POS terminal and immediately moved away from the POS terminal in any direction for a distance. In these examples, the electronic processor 122 may then in real-time infer with the user intention model 132 that the above situations indicate the user had an intention to make a purchase relative to the trigger event. In some examples, real-time is a timeframe that occurs in milliseconds or other suitable timeframe that occurs nearly immediately.

After receiving the payment data and confirming that the user of the mobile computing device 120 intended to make a purchase with the POS terminal 100, the wallet application 126 causes the electronic processor 122 to generate and communicate payment card details to the POS terminal 100. The POS terminal 100 uses the payment card details to process the purchase on a payment network.

In some examples, the wallet application 126 causes the electronic processor 122 to generate one or more graphical user interfaces. The wallet application 126 also causes the electronic processor 122 to control the display screen 136 to display the one or more graphical user interfaces.

The camera 134 includes an image sensor that generates and outputs image data. In some examples, the camera 134 includes a semiconductor charge-coupled device (CCD) image sensor, a complementary metal-oxide-semiconductor (CMOS) image sensor, or other suitable image sensor.

The display screen 136 is an array of pixels that generates and outputs images to a user. In some examples, the display screen 136 is one of a liquid crystal display (LCD) screen, a light-emitting diode (LED) and liquid crystal display (LCD) screen, a quantum dot light-emitting diode (QLED) display screen, an interferometric modulator display (IMOD) screen, a micro light-emitting diode display screen (mLED), a virtual retinal display screen, or other suitable display screen.

The one or more sensors 138 may include an accelerometer, a gyroscope, a camera (e.g., the camera 134), a light sensor, or other suitable sensor that senses an orientation of the mobile computing device 120. The electronic processor 122 controls the one or more sensors 138 to store the sensor data in the sensor data repository 130 of the memory 124.

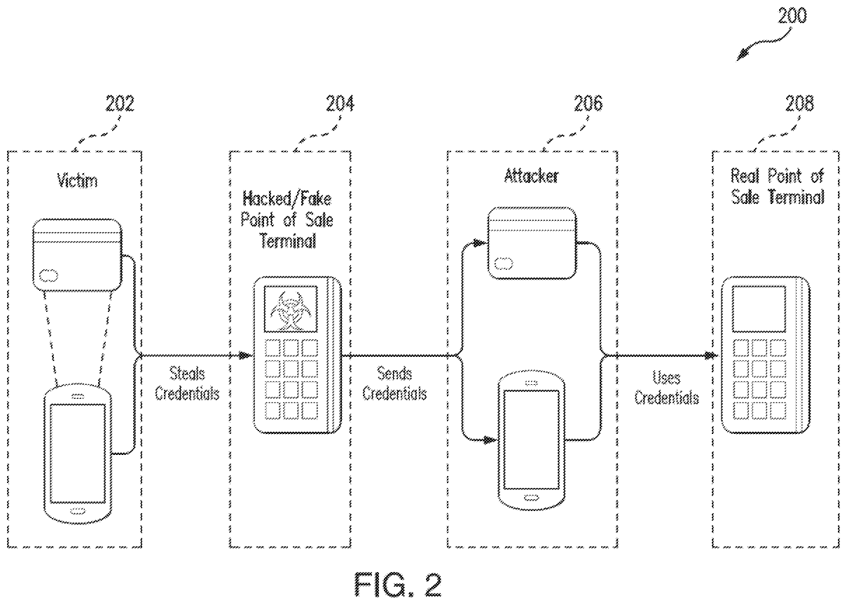

FIG. 2 is a diagram illustrating a first example 200 of a relay attack. In FIG. 2, the first example 200 of the relay attack includes a smartphone/digital payment card victim 202 (e.g., the mobile computing device 120 of FIG. 1), a hacked/fake POS terminal 204, a smartphone/digital payment card attacker 206, and a valid POS terminal 208 (e.g., the POS terminal 100 of FIG. 1).

As illustrated in FIG. 2, the smartphone/digital payment card victim 202 has payment credentials stolen by the hacked/fake POS terminal 204. The hacked/fake POS terminal 204 transmits the stolen payment credentials to the smartphone/digital payment card attacker 206. The smartphone/digital payment card attacker 206 uses the stolen payment credentials from the hacked/fake POS terminal 204 to make a purchase with the valid POS terminal 208.

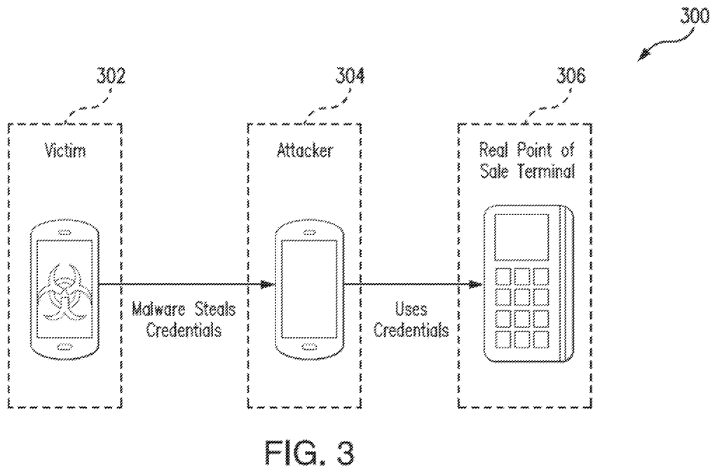

FIG. 3 is a diagram illustrating a second example 300 of a relay attack. In FIG. 3, the second example 300 of the relay attack includes a smartphone victim 302 (e.g., the mobile computing device 120 of FIG. 1), a smartphone attacker 304, and a valid POS terminal 306 (e.g., the POS terminal 100 of FIG. 1).

As illustrated in FIG. 3, the smartphone victim 302 has payment credentials stolen by a rogue application. The rogue application transmits the stolen payment credentials to the smartphone attacker 304. The smartphone attacker 304 uses the stolen payment credentials from the rogue application to make a purchase with the valid POS terminal 306.

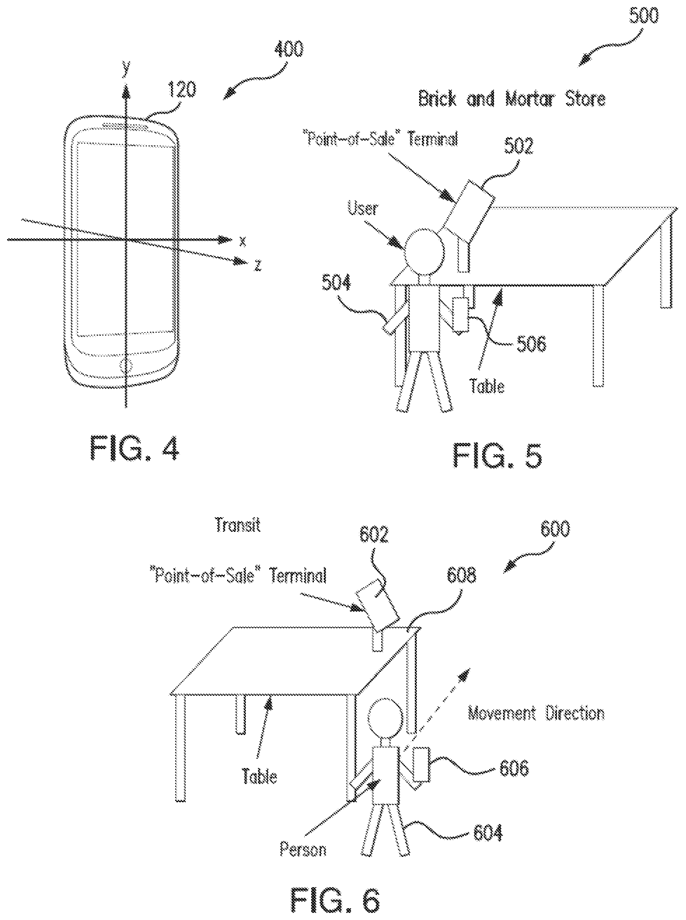

FIG. 4 is a diagram illustrating a spatial environment 400 of the mobile computing device 120 of FIG. 1, in accordance with various aspects of the disclosure. In the example of FIG. 4, the mobile computing device 402 (e.g., the mobile computing device 120 of FIG. 1) has a three-dimensional X-Y-Z orientation in the spatial environment 400.

Referring to FIG. 1, the user intention model 132 is a model that, in at least some instances, differentiates specific three-dimensional X-Y-Z orientations and/or changes in three-dimensional X-Y-Z orientations in the spatial environment 400 of the mobile computing device 120 that indicate an intent to make a purchase at the POS terminal 100. The user intention model 132 is a model that, in at least some instances, differentiates specific three-dimensional X-Y-Z orientations and/or changes in three-dimensional X-Y-Z orientations in the spatial environment 400 of the mobile computing device 120 that indicate an intent to not make a purchase at the POS terminal 100.

FIG. 5 is a diagram illustrating a first example 500 of identifying a user's intent at a payment terminal 502 of a brick and mortar store, in accordance with various aspects of the disclosure. In the example of FIG. 5, the first example 500 includes a POS terminal 502 (e.g., the POS terminal 100 of FIG. 1), a user 504, a mobile computing device 506 (e.g., the mobile computing device 120 of FIG. 1), and a table 508.

As illustrated in FIG. 5, the user 504 presents the mobile computing device 506 to the POS terminal 502 while standing (or sitting) at a table 508. Specifically, after the POS terminal 502 receives information regarding goods to be purchased, the user 504 presents the mobile computing device 506 executing the wallet application 126 of FIG. 1 to the POS terminal 502 and waits for a beep by the POS terminal 502. The user 504 then moves the mobile computing device 506 away from the POS terminal 502 and takes the purchased goods from the table 508.

In some examples, the brick and mortar store is a grocery store and the purchased goods are groceries. In other examples, the brick and mortar store is a restaurant and the purchased goods are one or more menu items. In yet other examples, the brick and mortar store is any physical store that has a POS terminal and sells goods and/or services.

FIG. 6 is a diagram illustrating a second example 600 of identifying a user's intent at a payment terminal 602 of a transit location, in accordance with various aspects of the disclosure. In the example of FIG. 6, the first example 600 includes a POS terminal 602 (e.g., the POS terminal 100 of FIG. 1), a user 604, a mobile computing device 606 (e.g., the mobile computing device 120 of FIG. 1), and a table 608.

As illustrated in FIG. 6, the user 604 presents the mobile computing device 606 to the POS terminal 602 while moving past the table 608 in a movement direction. Specifically, the user 604 presents the mobile computing device 606 executing the wallet application 126 of FIG. 1 to the POS terminal 602 and waits for a beep by the POS terminal 602. The user 604 then moves the mobile computing device 606 away from the POS terminal 602 and moves past the POS terminal 602 for a specific distance (e.g., three meters) in a single direction.

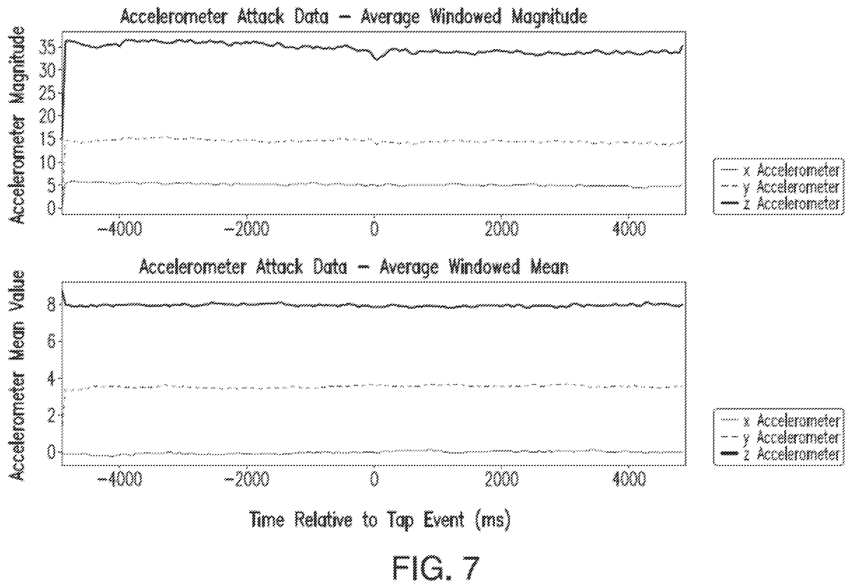

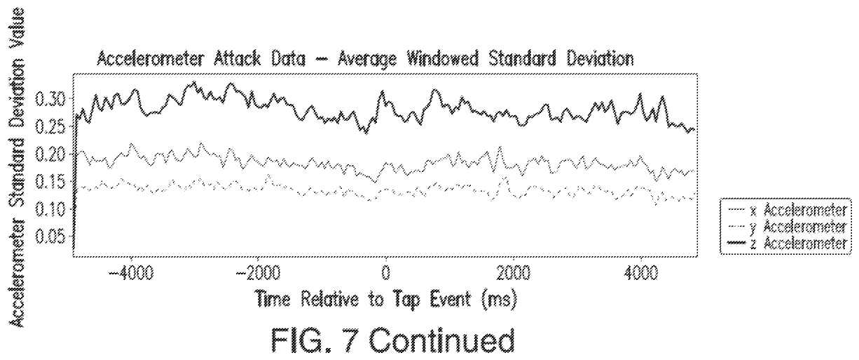

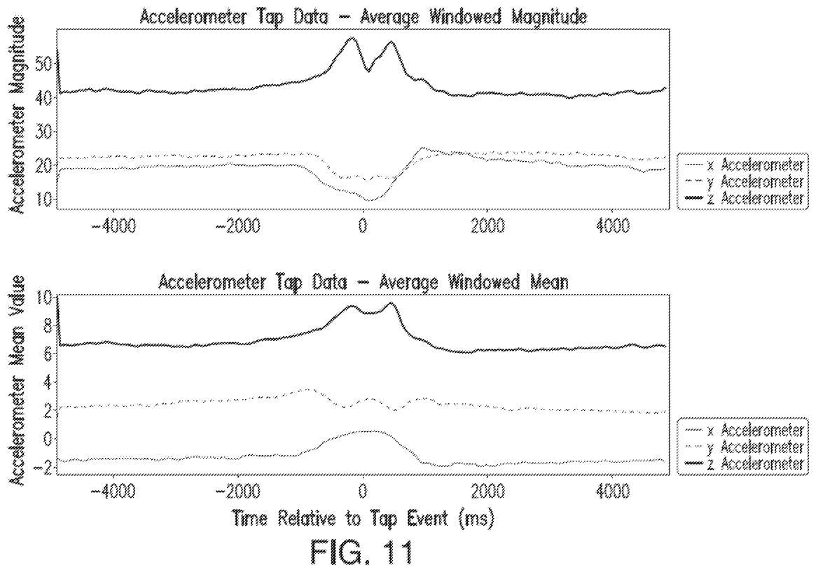

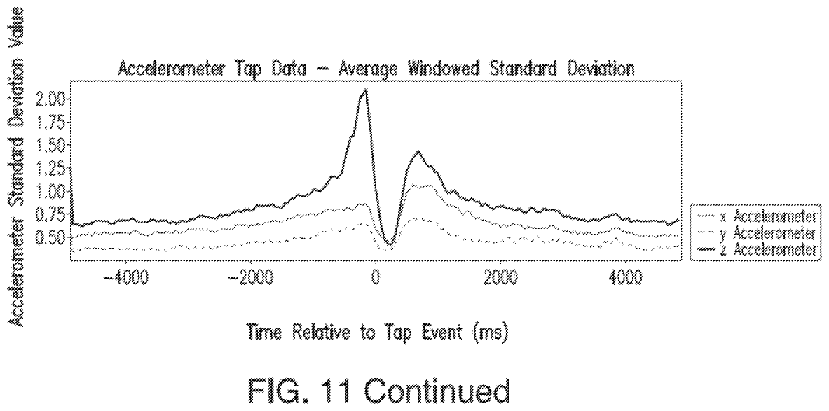

FIGS. 7-10 are diagrams 700-1000 illustrating results of attacks in the system of FIG. 1, in accordance with various aspects of the disclosure. FIGS. 11-14 are diagrams 1100-1400 illustrating results of payment taps in the system of FIG. 1, in accordance with various aspects of the disclosure.

The diagrams 700 and 1100 in FIGS. 7 and 11 show accelerometer attack data and tap data, respectively. The accelerometer attack data and the accelerometer tap data are presented across accelerometer dimensions and some metrics. As illustrated in FIGS. 7 and 11, the diagrams 700 and 1100 show visually that attack data and tap data are different.

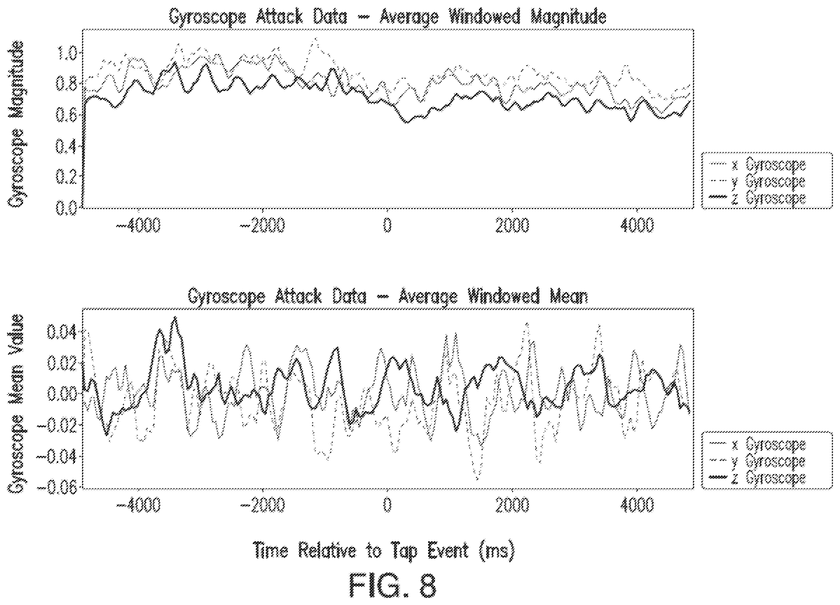

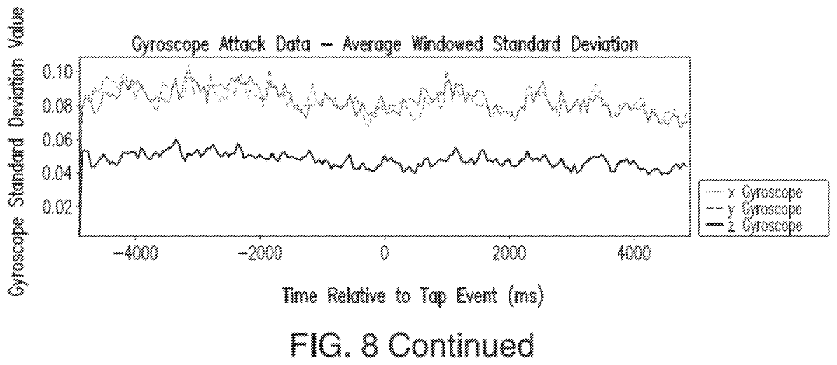

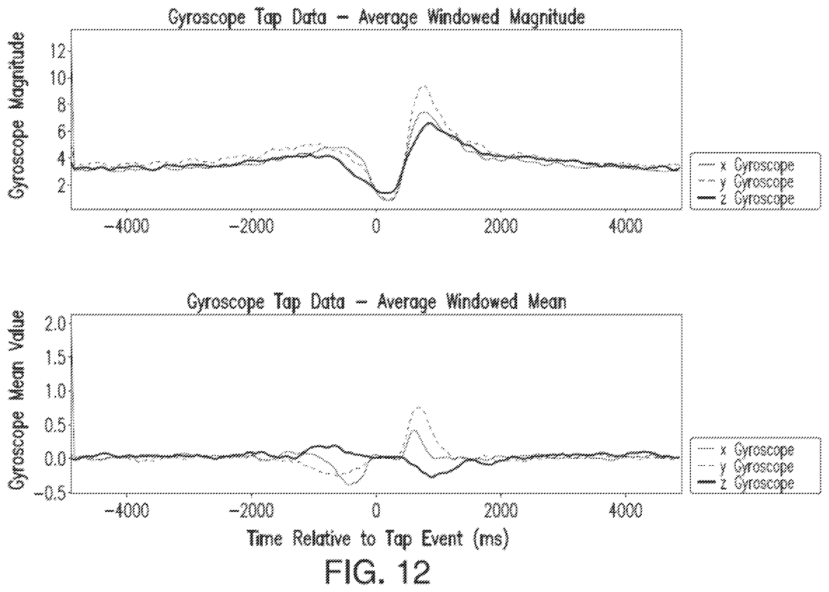

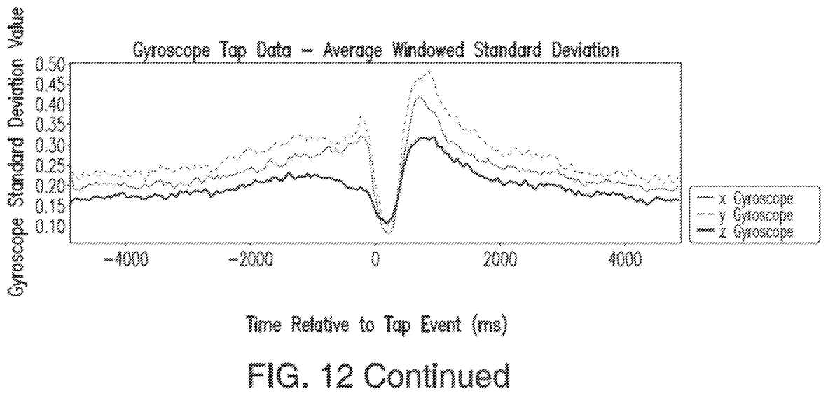

The diagrams 800 and 1200 in FIGS. 8 and 12 show gyroscope attack data and tap data, respectively. The gyroscope attack data and the gyroscope tap data are presented across different dimensions and some metrics. As illustrated in FIGS. 8 and 12, the diagrams 800 and 1200 show visually that attack data and tap data are different.

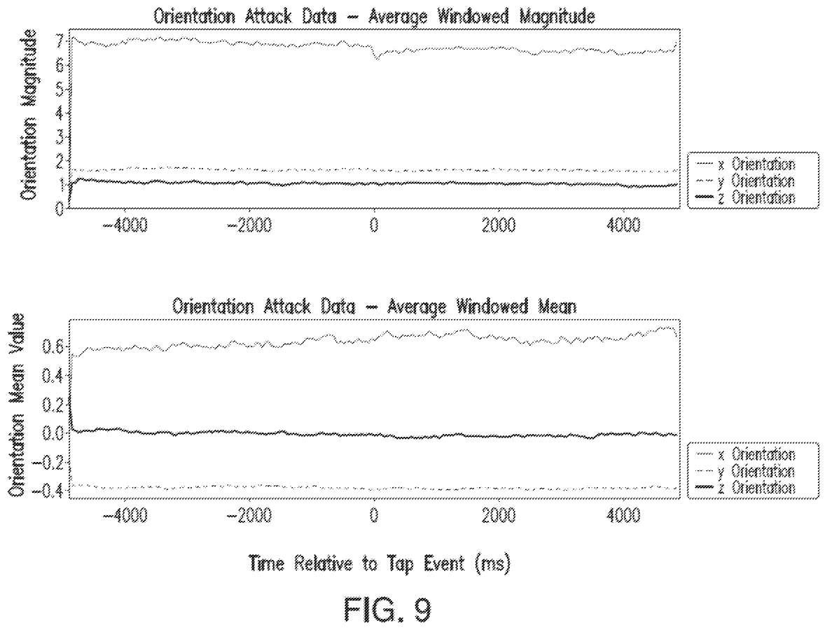

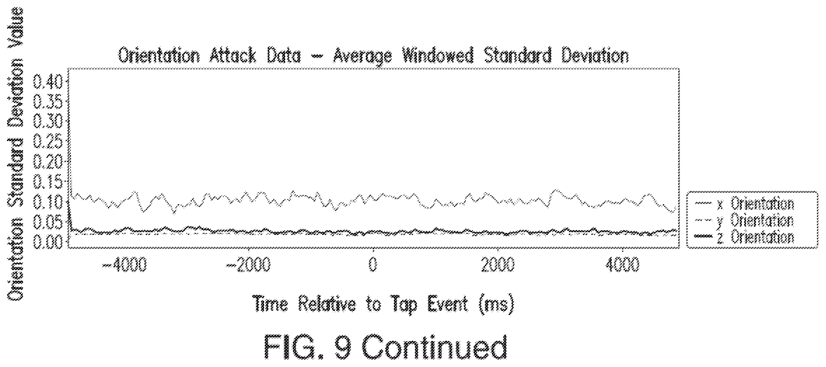

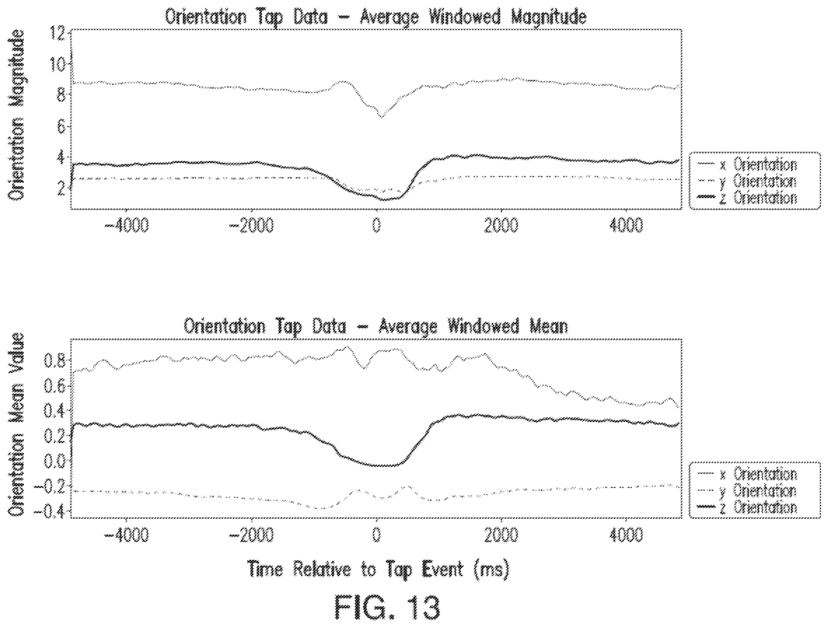

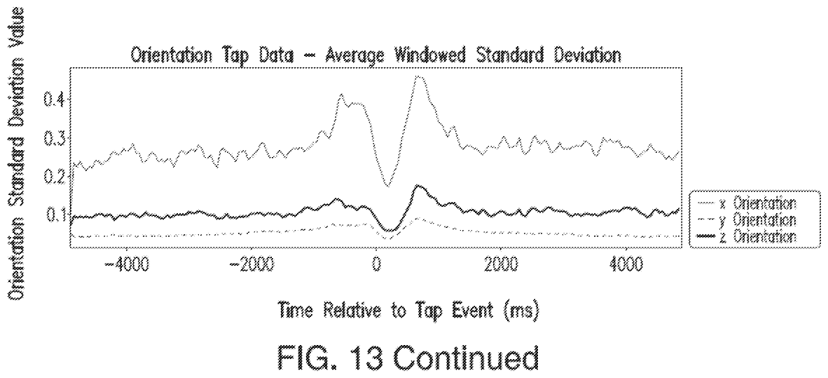

The diagrams 900 and 1300 in FIGS. 9 and 13 show orientation sensor attack data and tap data, respectively. The orientation sensor attack data and the orientation sensor tap data are presented across different dimensions and some metrics. As illustrated in FIGS. 9 and 13, the diagrams 900 and 1300 show visually that attack data and tap data are different.

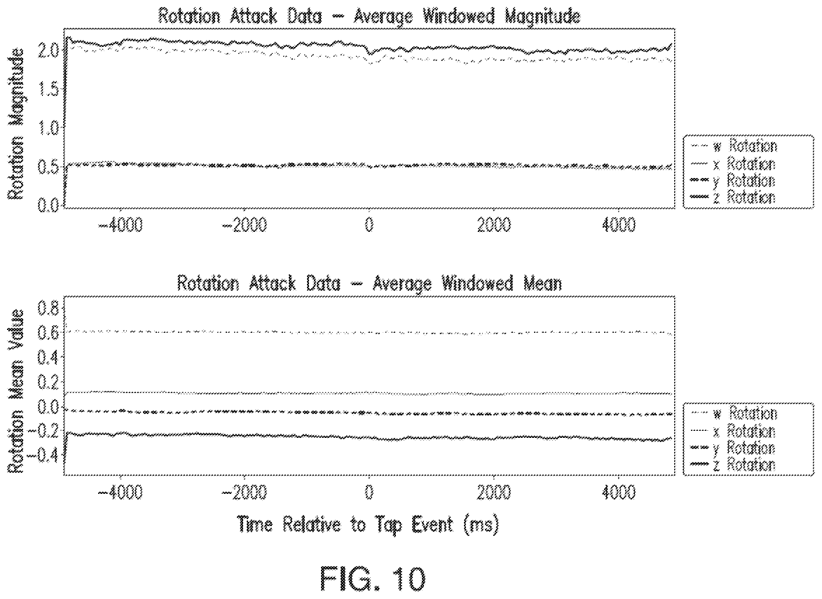

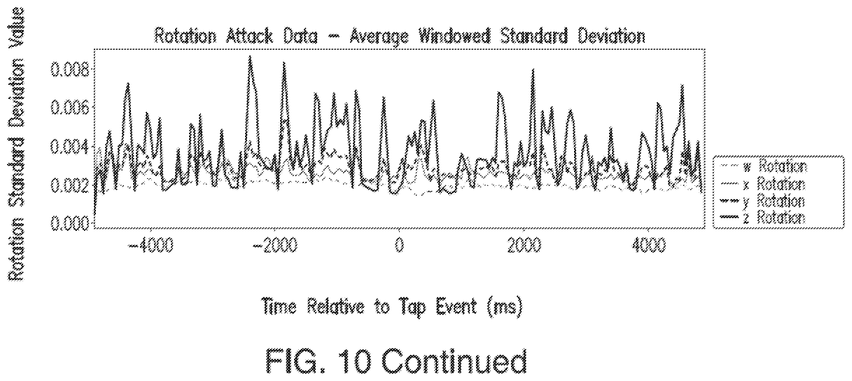

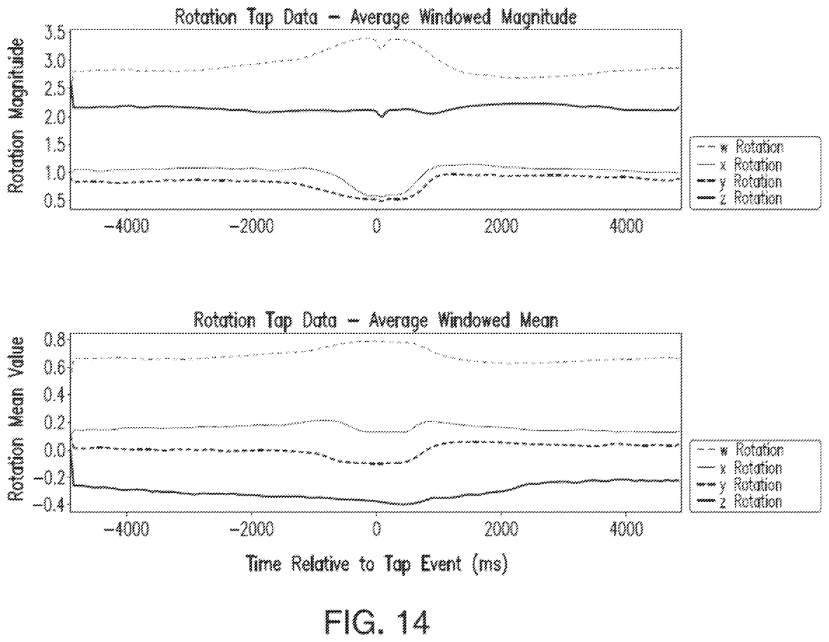

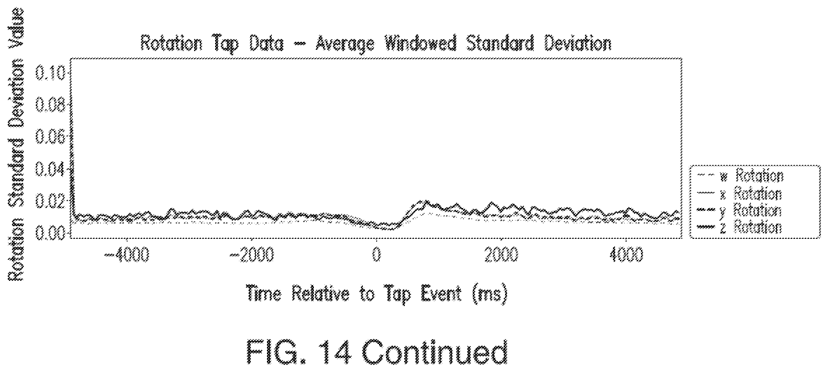

The diagrams 1000 and 1400 in FIGS. 10 and 14 show rotation sensor attack data and tap data, respectively. The rotation sensor attack data and the rotation sensor tap data are presented across different dimensions and some metrics. As illustrated in FIGS. 10 and 14, the diagrams 1000 and 1400 show visually that attack data and tap data are different.

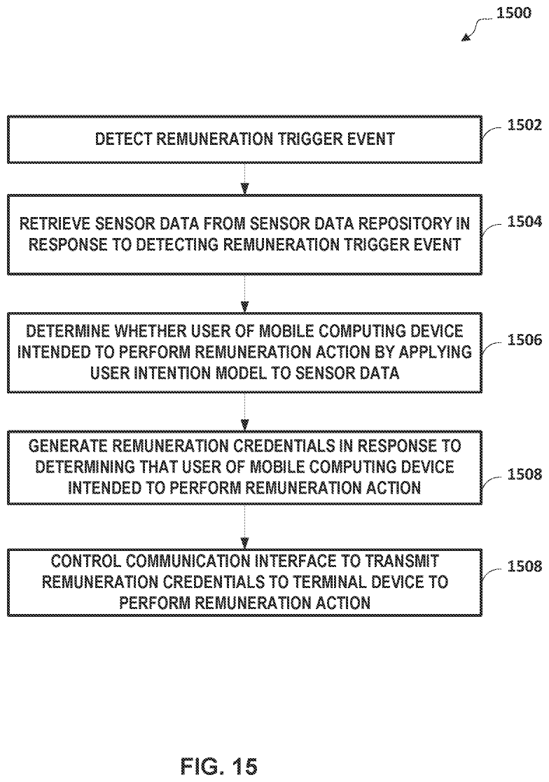

FIG. 15 is a flowchart illustrating an example method 1500 performed by the system 10 of FIG. 1, in accordance with various aspects of the disclosure. The method 1500 includes detecting, with an electronic processor, a remuneration trigger event (at block 1502). For example, detecting, with the electronic processor 122, a payment trigger event.

The method 1500 includes retrieving, with the electronic processor, sensor data from a sensor data repository in response to detecting the remuneration trigger event (at block 1504). For example, retrieving, with the electronic processor, sensor data from the sensor data repository 130 in response to detecting the payment trigger event.

The method 1500 includes determining whether a user of a mobile computing device intended to perform a remuneration action by applying a user intention model to the sensor data (at block 1506). For example, determining, with the electronic processor 122, whether a user of the mobile computing device 120 intended to make a purchase by applying the user intention model 132 to the sensor data.

The method 1500 includes generating remuneration credentials in response to determining that the user of the mobile computing device intended to make the purchase (at block 1508). For example, generating, with the electronic processor 122, payment credentials in response to determining that the user of the mobile computing device 120 intended to make the purchase.

The method 1500 also includes controlling a communication interface to transmit the remuneration credentials to a terminal device to complete the remuneration action (at block 1510). For example, controlling, with the electronic processor 122, the communication interface 112 to transmit the remuneration credentials to the POS terminal 100 to complete the purchase (at block 1510).

In some examples, detecting the remuneration trigger event further includes detecting an NFC communication with the POS terminal. In some examples, retrieving the sensor data from the sensor data repository in response to detecting the remuneration trigger event further includes retrieving the sensor data over a predetermined period of time. In some examples, a first portion of the predetermined period of time is prior to the remuneration trigger event, and wherein a second portion of the predetermined period of time is after the remuneration trigger event.

In some examples, determining whether the user of the mobile computing device intended to make the purchase by applying the user intention model to the sensor data further includes determining, with the user intention model and the sensor data, that the mobile computing device was presented to the POS terminal, determining, with the user intention model and the sensor data, that the mobile computing device was moved away from the POS terminal after a second predetermined period of time, and determining that the user of the mobile computing device intended to make the purchase in response to determining that the mobile computing device was presented to the POS terminal and the mobile computing device was moved away from the POS terminal after the second predetermined period of time.

In some examples, determining whether the user of the mobile computing device intended to make the purchase by applying the user intention model to the sensor data further includes determining, with the user intention model and the sensor data, that the mobile computing device was moved away from the POS terminal after the second predetermined period of time in a movement direction, and determining that the user of the mobile computing device intended to make the purchase in response to determining that the mobile computing device was presented to the POS terminal and the mobile computing device was moved away from the POS terminal after the second predetermined period of time in the movement direction.

In some examples, determining whether the user of the mobile computing device intended to make the purchase by applying the user intention model to the sensor data further includes determining that the user of the mobile computing device did not intend to make the purchase in response to determining that the mobile computing device was not presented to the POS terminal or the mobile computing device was not moved away from the POS terminal after the second predetermined period of time.

In some examples, determining whether the user of the mobile computing device intended to make the purchase by applying the user intention model to the sensor data further includes determining whether one or more non-remuneration scenarios occurred at a time of the remuneration trigger event. In these examples, the method 1500 may further include determining that the user of the mobile computing device did not intend to make the purchase in response to determining that the one or more non-remuneration scenarios occurred at the time of the remuneration trigger event.

Thus, the present disclosure provides, among other things, devices, computer-readable media, and systems for identifying remuneration gestures. Various features and advantages of the invention are set forth in the following claims.

What is claimed is:

1. A mobile computing device comprising:
a communication interface configured to communicate with a terminal device;
one or more sensors configured to generate sensor data associated with the mobile computing device;
a memory including a remuneration data repository configured to store remuneration data from the terminal device, a sensor data repository configured to store the sensor data that is generated by the one or more sensors, and a remuneration application including a user intention model; and
an electronic processor communicatively connected to the memory, and the one or more sensors, the electronic processor configured to
detect a remuneration trigger event,
retrieve the sensor data from the sensor data repository in response to detecting the remuneration trigger event,
determine whether a user of the mobile computing device intended to perform a remuneration action with the terminal device by applying the user intention model to the sensor data,
generate remuneration credentials in response to determining that the user of the mobile computing device intended to perform the remuneration action, and
control the communication interface to transmit the remuneration credentials to the terminal device to complete the remuneration action.

2. The mobile computing device of claim 1, wherein, to detect the remuneration trigger event, the electronic processor is further configured to detect an NFC communication with the terminal device.

3. The mobile computing device of claim 1, wherein, to retrieve the sensor data from the sensor data repository in response to detecting the remuneration trigger event, the electronic processor is further configured to retrieve the sensor data over a predetermined period of time.

4. The mobile computing device of claim 3, wherein a first portion of the predetermined period of time is prior to the remuneration trigger event, and wherein a second portion of the predetermined period of time is after the remuneration trigger event.

5. The mobile computing device of claim 1, wherein, to determine whether the user of the mobile computing device intended to perform the remuneration action by applying the user intention model to the sensor data, the electronic processor is further configured to
determine, with the user intention model and the sensor data, that the mobile computing device was presented to the terminal device,
determine, with the user intention model and the sensor data, that the mobile computing device was moved away from the terminal device after a second predetermined period of time, and
determine that the user of the mobile computing device intended to perform the remuneration action in response to determining that the mobile computing device was presented to the terminal device and the mobile computing device was moved away from the terminal device after the second predetermined period of time.

6. The mobile computing device of claim 5, wherein, to determine whether the user of the mobile computing device intended to perform the remuneration action by applying the user intention model to the sensor data, the electronic processor is further configured to
determine, with the user intention model and the sensor data, that the mobile computing device was moved away from the terminal device after the second predetermined period of time in a movement direction, and
determine that the user of the mobile computing device intended to perform the remuneration action in response to determining that the mobile computing device was presented to the terminal device and the mobile computing device was moved away from the terminal device after the second predetermined period of time.

7. The mobile computing device of claim 5, wherein, to determine whether the user of the mobile computing device intended to perform the remuneration action by applying the user intention model to the sensor data, the electronic processor is further configured to
determine that the user of the mobile computing device did not intend to perform the remuneration action in response to determining that the mobile computing device was not presented to the terminal device or the mobile computing device was not moved away from the terminal device after the second predetermined period of time.

8. The mobile computing device of claim 1, wherein, to determine whether the user of the mobile computing device intended to perform the remuneration action by applying the user intention model to the sensor data, the electronic processor is further configured to
determining whether one or more non-remuneration scenarios occurred at a time of the remuneration trigger event,
determine that the user of the mobile computing device did not intend to perform the remuneration action in response to determining the one or more non-remuneration scenarios occurred at the time of the remuneration trigger event.

9. A non-transitory computer-readable medium comprising instructions that, when executed by an electronic processor, cause the electronic processor to perform a set of operations comprising:
detecting a remuneration trigger event;
retrieving sensor data from a sensor data repository in response to detecting the remuneration trigger event;
determining whether a user of a mobile computing device intended to perform a remuneration action by applying a user intention model to the sensor data;
generating remuneration credentials in response to determining that the user of the mobile computing device intended to perform the remuneration action; and
controlling a communication interface to transmit the remuneration credentials to a terminal device to complete the remuneration action.

10. The non-transitory computer-readable medium of claim 9, wherein detecting the remuneration trigger event further includes detecting an NFC communication with the terminal device.

11. The non-transitory computer-readable medium of claim 9, wherein retrieving the sensor data from the sensor data repository in response to detecting the remuneration trigger event further includes retrieving the sensor data over a predetermined period of time.

12. The non-transitory computer-readable medium of claim 11, wherein a first portion of the predetermined period of time is prior to the remuneration trigger event, and wherein a second portion of the predetermined period of time is after the remuneration trigger event.

13. The non-transitory computer-readable medium of claim 9, wherein determining whether the user of the mobile computing device intended to perform the remuneration action by applying the user intention model to the sensor data further includes
determining, with the user intention model and the sensor data, that the mobile computing device was presented to the terminal device,
determining, with the user intention model and the sensor data, that the mobile computing device was moved away from the terminal device after a second predetermined period of time, and
determining that the user of the mobile computing device intended to perform the remuneration action in response to determining that the mobile computing device was presented to the terminal device and the mobile computing device was moved away from the terminal device after the second predetermined period of time.

14. The non-transitory computer-readable medium of claim 13, wherein determining whether the user of the mobile computing device intended to perform the remuneration action by applying the user intention model to the sensor data further includes
determining, with the user intention model and the sensor data, that the mobile computing device was moved away from the terminal device after the second predetermined period of time in a movement direction, and
determining that the user of the mobile computing device intended to perform the remuneration action in response to determining that the mobile computing device was presented to the terminal device and the mobile computing device was moved away from the terminal device after the second predetermined period of time in the movement direction.

15. The non-transitory computer-readable medium of claim 13, wherein determining whether the user of the mobile computing device intended to perform the remuneration action by applying the user intention model to the sensor data further includes
determining that the user of the mobile computing device did not intend to perform the remuneration action in response to determining that the mobile computing device was not presented to the terminal device or the mobile computing device was not moved away from the terminal device after the second predetermined period of time.

16. The non-transitory computer-readable medium of claim 9, wherein determining whether the user of the mobile computing device intended to perform the remuneration action by applying the user intention model to the sensor data further includes determining whether one or more non-remuneration scenarios occurred at a time of the remuneration trigger event,
wherein the set of operations further includes determining that the user of the mobile computing device did not intend to perform the remuneration action in response to determining that the one or more non-remuneration scenarios occurred at the time of the remuneration trigger event.

17. A system comprising:
a terminal device configured to
communicate with a remuneration network,
receive NFC communications, and
send remuneration data in response to receiving the NFC communications; and
a mobile computing device including
a communication interface configured to communicate with the terminal device;
one or more sensors configured to generate sensor data associated with the mobile computing device;
a memory including a remuneration data repository configured to store remuneration data from the terminal device, a sensor data repository configured to store the sensor data that is generated by the one or more sensors, and a wallet application including a user intention model; and
an electronic processor communicatively connected to the memory, and the one or more sensors, the electronic processor configured to
detect a remuneration trigger event,
retrieve the sensor data from the sensor data repository in response to detecting the remuneration trigger event,
determine whether a user of the mobile computing device intended to perform a remuneration action by applying the user intention model to the sensor data,
generate remuneration credentials in response to determining that the user of the mobile computing device intended to perform the remuneration action, and
control the communication interface to transmit the remuneration credentials to the terminal device to complete the remuneration action.

18. The system of claim 17, wherein the communication interface is further configured to transmit the NFC communications to the terminal device, and wherein the electronic processor is further configured to detect the remuneration trigger event based on the NFC communications transmitted to the terminal device.

19. The system of claim 17, wherein, to retrieve the sensor data from the sensor data repository in response to detecting the remuneration trigger event, the electronic processor is further configured to retrieve the sensor data over a predetermined period of time.

20. The system of claim 19, wherein a first portion of the predetermined period of time is prior to the remuneration trigger event, and wherein a second portion of the predetermined period of time is after the remuneration trigger event.
